(19) United States
(12) Patent Application Publication
(10) Pub. No.: US 2010/0149611 A1
(43) Pub. Date: Jun. 17, 2010

(54) Method and Apparatus for Reconstructing a Three-Dimensional Scene in a Holographic Display

(75) Inventor: Norbert Leister, Dresden (DE)

Correspondence Address: Saul Ewing LLP (Philadelphia), Attn: Patent Docket Clerk, 2 North Second St., Harrisburg, PA, 17101, US

(73) Assignee: SeeReal Technologies S.A., Munsbach (LU)

(21) Appl. No.: 12/600,372

(22) PCT Filed: May 9, 2008
(86) PCT No.: PCT/EP2008/055746

§ 371 Date: Nov. 16, 2009

(30) Foreign Application Priority Data
May 16, 2007 (DE) 10 2007 023 738.5

(51) Int. Cl. G03H 1/22; G06T 15/50

(52) U.S. Cl. 359/32; 345/426

(57) ABSTRACT

A method is disclosed for reconstructing a three-dimensional scene in a holographic display. A 3D scene that is to be reconstructed is decomposed into object points, and one respective object point is encoded as a sub-hologram in the light modulator. Processor means and reconstruction means are provided for calculating and encoding as well as for reconstructing the 3D scene in order to overcome known drawbacks encountered when encoding a hologram and holographically reconstructing the 3D scene in holographic display devices. Processor elements are provided for generating a movable two-dimensional grid in the light modulating means, forming groups of object points from grid-related object points, and sequentially encoding the holograms of said groups of object points, by means of which intrinsically coherent partial constructions of the groups of object points are generated in a rapid sequence, said partial constructions being incoherent relative to one another.

The present invention relates to a method for reconstructing a three-dimensional scene in a holographic display, where the three-dimensional scene (3D scene) is divided into individual object points which are encoded as sub-holograms on a spatial light modulator means. Light sources of an illumination system illuminate the light modulator means with sufficiently coherent light. Partial holographic reconstructions of the 3D scene are generated according to the method of this invention by the wave fronts which are sequentially modulated with information in a reconstruction space and can be seen from an eye position within a visibility region. The present invention also relates to a device for implementing the method and to a holographic display for using the method and device.

The present invention can be applied in such fields where a very detailed and realistic spatial representation of 3D scenes can be improved by using holographic displays.

The present invention can be realised either in a direct-view display or in a projection display, both having a visibility region which lies in the plane of the back-transform of the encoded hologram within a periodicity interval of the used transformation, and which is also referred to as ‘observer window’.

The holographic reconstruction of the 3D scene is preferably realised by illuminating a light modulator means with sufficiently coherent light in conjunction with an optical reconstruction system in a reconstruction space, which stretches between the visibility region and the light modulator means. Each object point of the encoded 3D scene contributes with a wave front to a resultant superposed light wave front, which can be perceived as the reconstruction of the 3D scene from the visibility region. The extent of the visibility region can be adapted such to have about the size of an eye pupil. A separate visibility region can be created for each observer eye. If the observer moves, then the visibility region(s) will be tracked accordingly using suitable means.

In order to be able to watch the reconstruction of the 3D scene, the observer can look onto a light modulator means on which the hologram of the 3D scene is directly encoded, and which serves as a screen. In this document, this arrangement will be referred to as ‘direct-view display’. Alternatively, the observer can look onto a screen onto which either an image or a transform of the hologram values which are encoded on the carrier medium is projected. In this document, this arrangement will be referred to as ‘projection display’.

The eye positions are detected in a generally known manner by a position finder. The principle of such displays is known from earlier documents filed by the applicant, e.g. from (1) EP 1 563 346 A2, (2) DE 10 2004 063 838 or (3) DE 10 2005 023 743 A1.

For encoding a hologram, a number of methods are known which take into consideration the properties of the provided light modulator means.

As initially described in the method for computing holograms in document (2), the 3D scene to be reconstructed is divided by programming means for the computation of the hologram values into section layers which are parallel to a reference plane and, in these section layers, further into individual points in a grid, where the points in this document are object points. Each object point is encoded on a light modulator means in a certain region of the encoding surface and is then reconstructed by this region. This region carries the sub-hologram of this object point. The sub-hologram corresponds roughly to a holographically encoded lens function which reconstructs this one object point in its focal point.

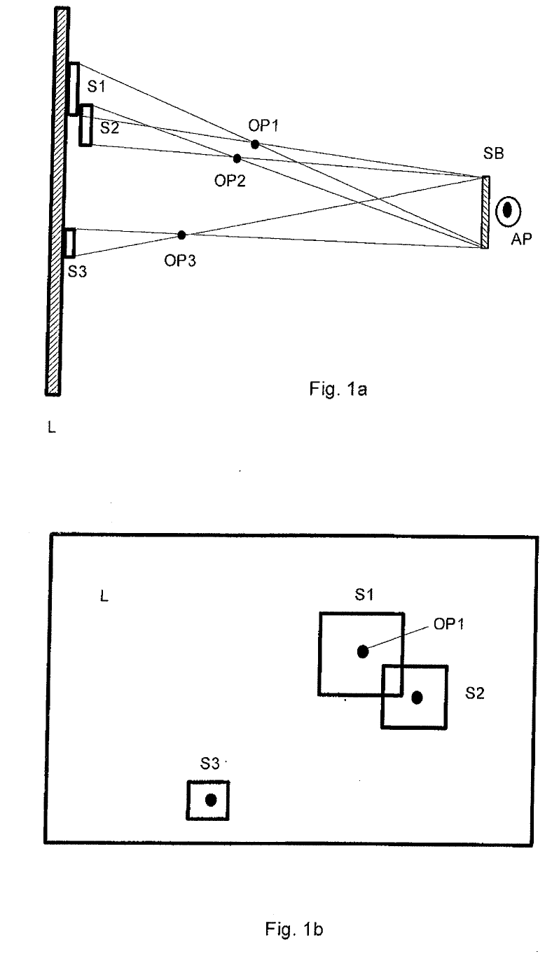

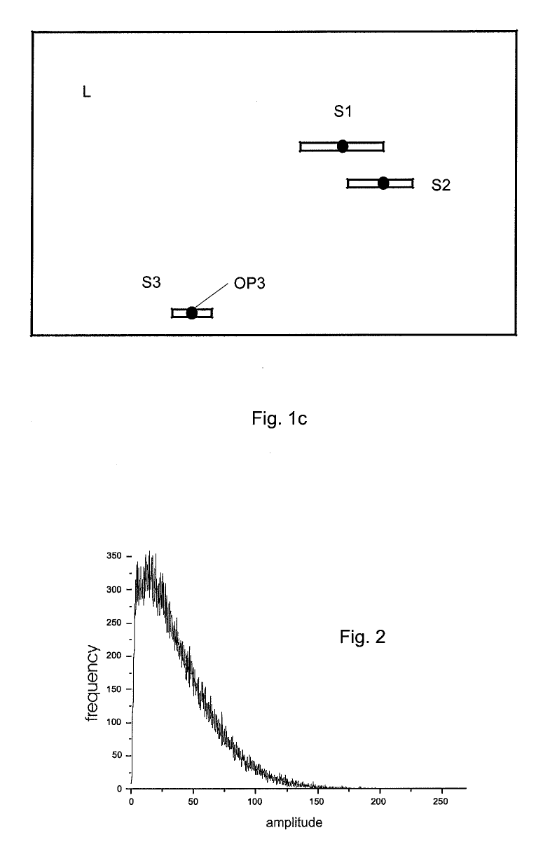

This is shown exemplarily in FIG. 1a, where two-dimensional sub-holograms S1, S2 and S3 of three object points OP1, OP2 and OP3 from three different section layers (not shown) of the 3D scene are encoded in the controllable elements of a light modulator means L. The sub-holograms S1 to S3 here have a certain extent in the horizontal and vertical direction and they all lie in the same modulator plane. To facilitate understanding of the overlapping effect, S2 is shown at a distance to the modulator plane. Each sub-hologram only reconstructs one object point of the 3D scene, which is visible from an eye position AP in a visibility region SB. In individual pixels of the light modulator means L, the information of the sub-holograms S1 and S2 of the adjacent object points OP1 and OP2 is overlapped, as shown in FIG. 1b, where only the object point OP1 is indicated. The sub-hologram S3 of the more distant object point OP3 is encoded in a different region of the light modulator means L, and does not overlap. The more object points a 3D scene is made up of, the more the corresponding sub-holograms will overlap. The entirety of all sub-holograms generally represents the reconstruction of the entire 3D scene. The complex values of the overlapping sub-holograms must be added during hologram computation and thus demand additional computational load and memory capacity. The complex values are generally represented by the transparency values of a hologram. The term ‘transparency value’ is used here as a generic term. It can also refer to reflectivity in reflection-type light modulators, or to phase values.

If, for example, a 3D scene which only comprises one object point is to be entirely reconstructed, complex values had to be written for this object point to the region of the light modulator means where the sub-hologram is located. The absolute value of the complex value, i.e. the amplitude, is about constant across the entire sub-hologram, and its magnitude depends on the axial distance of the object point to the screen and on the luminous intensity of the object point. The phase distribution of the complex values near the sub-hologram corresponds roughly to the function of a lens whose focal length depends on the axial distance of the object point to the light modulator means or screen. Outside the sub-hologram, the value ‘0’ had to be written to the light modulator means for this object point. Only those pixels of the light modulator which are within the sub-hologram would thus contribute with their entire transmittance to the reconstruction of that single object point.

In contrast, in a conventional Fourier hologram, where a reconstruction of the 3D scene is created in the Fourier plane of a hologram, each object point of a reconstruction is reconstructed by the entire hologram. Information of all object points of the reconstruction is superimposed in each pixel of a light modulator. The complex values in the modulator pixels must thus be added for all object points. On the other hand, each pixel of the hologram also contributes to the reconstruction of all object points. If for example a Fourier hologram was divided into multiple small sub-holograms, each sub-hologram would continue to reconstruct the entire 3D scene.

In contrast to a Fourier hologram, complex values are here only added in the overlapping section of the sub-holograms for the holograms computed according to (1) and (2). The addition of the complex values here results in a distribution of amplitude values between zero and a maximum occurring amplitude in a range of values which will be referred to below as ‘dynamic range’, and which is shown in FIG. 2. The drawing shows exemplarily the frequency of individual amplitudes which occur in a hologram after addition of all overlapping sub-holograms. In order to write the hologram to a light modulator means, the values here must be normalised to the maximum amplitude.

If the complex values are written to a light modulator means which modulates the amplitude and/or phase of light, only a limited number of amplitude levels and/or phase levels can be realised. For example, a typical amplitude-modulating light modulator can display 256 greyscale values, which corresponds to a resolution of 8 bits, i.e. 2 to the power of 8 greyscale values, and which defines the greyscale range or the bit depth of a light modulator means.

The larger the dynamic range of a hologram and the smaller the bit depth of a light modulator means, the more errors occur while encoding the hologram values. These errors will be referred to as ‘quantification errors’ below.

The dynamic range also affects the diffraction efficiency of the light modulator means. If holograms are encoded for example on an amplitude-modulating light modulator such that the maximum amplitude is also represented by the greyscale value with maximum transmittance of the modulator, a large dynamic range will cause multiple modulator pixels to be assigned with greyscale values with low transparency. However, these multiple modulator pixels only have a low transmittance. A large portion of the light is thus absorbed by the modulator so that it will not be available for the reconstruction.

In contrast, a hologram computed according to (1) and (2) has a smaller dynamic range than a Fourier hologram for comparable objects, because only sub-holograms of a small portion of all object points overlap and must be added.

Although the described disadvantages of quantification errors and diffraction efficiency are much less grave in the method described in (1) and (2) than in a Fourier hologram, they still exist and can be disturbing.

Light modulator means which are referred to as binary light modulator means are also known for reconstructing a hologram. For those binary light modulator means, only two different values can be controlled directly; in an amplitude-modulating light modulator for example only the amplitudes 0 and 1, and in a phase-modulating light modulator only the phases 0 and π.

A ferro-electric liquid crystal modulator (FLC) serves as an example of a binary light modulator means. The pulse width modulation (PWM) is one possibility for the reproduction of greyscale values on this modulator for representing conventional two-dimensional image contents, e.g. television images. Individual pixels are turned on or off for variable periods of time in order to achieve a different temporally averaged luminous intensity for an eye.

However, this method can not be applied analogously to a holographic display device because sufficiently coherent light must be provided for a reconstruction. If for example amplitudes of a hologram with a large dynamic range were reproduced on a binary light modulator by way of pulse width modulation, a sequence of incoherent partial reconstructions would occur; which if averaged would render a reconstruction visible which deviates from the 3D scene to be reconstructed, instead of a coherent reconstruction. Thus, only binary holograms can typically be represented on a binary light modulator with toleration of substantial quantification errors. Iterative computation methods for reducing quantification errors in binary holograms are known, but cause a great computational load in order to reduce reconstruction errors, and cannot entirely compensate them.

Binary holograms are typically real-valued, which means that only symmetric reconstructions are possible. This forms a substantial limitation of the reconstruction. Binary holograms which represent other values than (0, π) or (0, 1) also generally show these characteristics.

Documents (1) and (2) describe the reconstruction of individual object points by one sub-hologram each which has a lens function. As known from the Fresnel zone plate, a lens function can be realised with a binary amplitude or phase structure. However, the binary structure does not allow to distinguish between a lens with the focal length +f and a lens with the focal length −f. An observer who watches from the observer window a reconstruction of a binary sub-hologram in the form of such a zone plate would always see in addition to an object point in front of the display another corresponding object point of like intensity behind the display. A binary modulator thus allows 3D scenes to be reconstructed, but in addition to the 3D scene in front of the display one would always see a mirror image of that scene behind the display. This will only change if at least three phase levels are realised in a phase-modulating light modulator.

Further, it must be noted that a combination of at least two light modulators are required in order to fully encode any complex numbers. For example, one amplitude-modulating light modulator and one phase-modulating light modulator or two phase-modulating light modulators are used, but this requires a difficult mechanical adjustment of the modulator panels because the pixel grid of the two modulator panels must be congruent.

In addition to the use of multiple modulators, an encoding method which is specially adapted to the individual modulators will be necessary. It is for example known that a complex number can be encoded by multiple amplitude values, but this has the disadvantage of a small diffraction efficiency. If, in contrast, a complex number is encoded by multiple phase values, the two-phase encoding method is preferably used. However, since that method causes reconstruction errors, and since a distribution of more than two phase values, i.e. a larger dynamic range, is generated as multiple sub-holograms are added, it must thus additionally be combined with iterative computation methods.

The reconstruction errors caused by phase encoding must be compensated with a considerably longer computation time for the hologram. However, this is unacceptable for real-time representations in holographic displays.

In summary, it must be noted that it cannot be avoided that multiple sub-holograms with the given small bit depth are overlapping in a hologram which is computed according to (1) and (2) and where the 3D scene is divided into object points for which sub-holograms are computed and encoded. This bit depth turns out to be too small for the large dynamic ranges, which adversely affects the reconstruction quality of the 3D scene.

If a 3D scene shall be optimally reconstructed by light modulator means with small bit depth, all object points must be encoded such that their sub-holograms will not overlap. This can be achieved if each single object point is sequentially encoded and reconstructed, where the light modulator means to be used must have a very fast switching speed. However, known fast spatial light modulator means available today are of binary type. A conventional hologram representation on a binary light modulator is inadequate to achieve a high reconstruction quality, for the above-described reasons.

It is the object of this invention to compensate or at least to reduce the above-described disadvantages of the prior art when encoding a hologram of a 3D scene and when holographically reconstructing the 3D scene in a real-time holographic display device, where the holograms shall be encoded based on complex transparency values, taking advantage of a small dynamic range. The method shall further be designed such that at least one spatial light modulator with small bit depth and fast switching speed can be used, that the computational load for computing the hologram is reduced and that a good reconstruction quality is achieved.

The method according to the present invention is based on a 3D scene to be reconstructed, which is divided according to the description in document (2) into a number of section layers with a grid each, thus making it possible to define a number of object points, where for each of which a sub-hologram is computed and encoded on a light modulator means.

The light modulator means can be a pixelated light modulator with a discrete arrangement of controllable elements (pixels), or a light modulator with a continuous, non-pixelated encoding surface, which is formally divided into discrete areas by the information to be displayed. Such a discrete area then has the same function as a pixel. During the passage of coherent light through the light modulator, the controllable elements modulate the amplitude and/or phase of the light in order to reconstruct the object points of the 3D scene.

The method is further based on an illumination system with at least one light source which emits sufficiently coherent light and with at least one optical projection means, said illumination system illuminating a spatial light modulator means. The 3D scene is reconstructed by the wave fronts which are modulated with the information of the object points within a reconstruction space, which stretches between a light modulator means or a screen and a visibility region. The reconstruction is visible for an observer from an eye position in a visibility region, said eye position being detected by a position finder. The method further uses a processor with processor elements for computing and encoding the 3D scene, and its process steps according to this invention are characterised in that
A first processor element (PE1)
   Generates in the light modulator means (L) a displaceable, two-dimensional grid (MR) with regularly arranged grid cells for encoding the sub-holograms (Sn),
   Selects object points (OPn) depending on the set positions of the grid cells and aggregates them to form object point groups (OPGm), and
   Simultaneously computes the sub-holograms (Sn) of the object points (OPn) of a generated object point group (OPGm) and simultaneously encodes them as a common hologram of the object point group (OPGm) in a separate grid cell each of the light modulator means (L), where the common holograms of all object point groups (OPGm) are encoded sequentially, and
A second processor element (PE2) controls the illumination system in synchronism with the displacement of the grid on the light modulator means (L) such that intrinsically coherent but mutually incoherent partial reconstructions of the object point groups (OPGm) are generated from the multitude of sequentially encoded holograms at a fast pace and superposed sequentially in the visibility region (SB). The partial reconstructions of the 3D scene can thus be seen from the eye position as a singular, temporally averaged reconstruction.

Thanks to the displaceable grid, all object points of the 3D scene can be precisely associated with the regularly arranged two-dimensional grid cells on the light modulator means, and certain object points can be selected for forming object point groups based on a criterion. The formation of object point groups preferably simplifies encoding and reconstructing the 3D scene and considerably reduces the computing time compared to encoding and reconstructing the 3D scene object point by object point.

According to the embodiment of the method, the first processor element for selecting object points defines in the reconstruction space a depth range confined by two planes, which comprises all object points which contribute to the reconstruction of the 3D scene, and which defines the surface area of their sub-holograms on the light modulator means by way of projections from the visibility region. The sub-holograms do thus not overlap. The maximum surface area of a single sub-hologram is defined by the axial distance between one of the two planes of the defined depth range and the plane of the visibility region. If the reconstruction is watched in front of the screen, one of the planes is the plane of the defined depth range in the reconstruction space which is closest to the observer. In contrast, the farthest plane of the defined depth range determines the maximum surface area of the sub-hologram, if the reconstruction appears behind the screen. In a large 3D scene, which is reconstructed partly in front of and partly behind the light modulator means, the larger surface area of the two surface areas of the sub-hologram shall be used.

This means that the first processor element defines the surface area of a grid cell of the grid such that it corresponds with the largest sub-hologram. This definition ensures that a single sub-hologram does not exceed the size of a grid cell.

Further, the depth range is limited to a maximum axial distance in front of and, optionally, behind the light modulator means, so that the reconstruction of the entire 3D scene is always generated within the reconstruction space.

The object points are selected depending on their spatial position in relation to a grid cell of the generated grid, and are combined to form an object point group. The centred position of an object point in the depth range in relation to a grid cell of the generated grid at a certain point of time is preferably defined as the criterion for selecting the object point. Centred position here means that an imaginary line from the centre of the observer window through the object point also runs through the centre of a grid cell. Object points which fulfil this criterion form an object point group. Another object point group is made up of object points of the 3D scene in that the grid is displaced by at least one pixel of the light modulator means, controlled by software means in the first processor element. The displacement is only carried out in the horizontal direction for a one-dimensional hologram and in the horizontal and vertical direction for a two-dimensional hologram, depending on the applied encoding method. The formation of object point groups is completed when the grid has been displaced horizontally and/or vertically in steps of at least one pixel, so that altogether a displacement by one full grid cell has been achieved. All different positions of all object points of the 3D scene in the defined depth range are thus detected.

Another process step is characterised in that the found sub-holograms of the 3D scene are simultaneously encoded on the light modulator means in the horizontal and vertical direction, because they do not overlap. A sub-hologram can be encoded in one dimension or in two dimensions in adjacent pixels of a grid cell, depending on the encoding method.

A sub-hologram has a maximum size, which is preferably computed according to the equation

np_{x,y}=|z/(D−z)|*Dλ/p_{x,y}² (1)

where z is the axial distance between an object point and the light modulator means or a screen, D is the distance of the visibility region to the light modulator means or a screen, λ is the wavelength of the light of a light source used in the illumination system, and p_{x,y} denotes the width (pₓ) and height (p_{y}) of a macro pixel. A macro pixel here is either a single pixel or a group of adjacent pixels to which a complex value is written.

According to another embodiment of the method, a position controller controlled by the processor adapts the direction of propagation of the modulated wave fronts of the common holograms to the current eye position of an observer eye as detected by a position finder, in order to continuously provide an observer in front of the screen with a reconstruction, if the observer moves to another position.

According to the embodiments, the light modulator means can be transmissive, transflective or reflective light modulator means. Light modulator means for implementing the method can further be used individually or as combination of at least one phase-modulating light modulator and one amplitude-modulating light modulator. If two light modulators are combined, the amplitude-modulating light modulator will preferably generate a frame around a single sub-hologram. The frame width depends on the luminous intensity and the axial distance of an object point to the screen and defines the surface area of the sub-hologram in the grid cell, where the frame represents the non-transparent region of the grid cell.

It is further suggested according to the method, that the light modulator means on which the holograms are encoded directly serves as screen. This way, a direct-view display is realised. In contrast, in a projection display, the screen is an optical element onto which a hologram encoded on the light modulator means, or a wave front of the 3D scene encoded on the light modulator means, is projected. In the projection display with combined light modulators according to the present invention it is for example provided that the amplitude-modulating light modulator generates a frame preferably around a single sub-hologram.

Another embodiment of the method provides that a temporally averaged visible luminous intensity of object points is controlled by reconstructing the object points in a sufficiently coherent manner for variable periods of time, here defined as T2 by example.

Further, the luminous intensity of one or multiple light sources is varied in order to realise variable luminous intensities during the reconstruction of object points. Only individual grid cells or the entire light modulator means are illuminated at variable intensity. This means that in addition to the variation of the period of time T2 during which individual object points are reconstructed, the luminous intensity of the illuminating light is also modified during a different period of time T1.

The object is further solved by a device for reconstructing a 3D scene, comprising
An illumination system with at least one light source which emits sufficiently coherent light for illuminating at least one spatial light modulator means, which is assigned with at least one optical projection means,
Reconstruction means for reconstructing the 3D scene which is divided into individual object points, within a reconstruction space which stretches between the light modulator means and a visibility region, where the reconstruction is visible from an eye position in the visibility region, and
A processor with processor elements for computing and encoding sub-holograms of the 3D scene,

For implementing the method according to one of the preceding claims, characterised in that
A first processor element is provided for generating a displaceable, two-dimensional grid with regularly arranged grid cells on the light modulator means, for defining a depth range in the reconstruction space, for generating object point groups from object points of the 3D scene, for computing a multitude of sub-holograms of the object points of a generated object point group, and for simultaneously encoding the sub-holograms as a common hologram of the respective object point group in a separate grid cell each, where the common holograms of all object point groups are encoded sequentially, and
A second processor element is provided for controlling the illumination system in synchronism with the displacement of the grid on the light modulator means such that intrinsically coherent but mutually incoherent partial reconstructions of the object point groups are generated from the multitude of sequentially encoded holograms at a fast pace and superposed sequentially in the visibility region. The partial reconstructions of the 3D scene can thus be seen by an observer eye from the eye position as a singular, temporally averaged reconstruction.

The device is preferably a holographic display in the form of a direct-view display or a projection display. If it is a direct-view display, the device further comprises a light modulator means which serves as a screen. If it is a projection display, the screen is an optical element onto which a hologram encoded on the light modulator means, or a wave front of the 3D scene encoded on the light modulator means, is projected.

According to another novel object of the invention, the grid comprises a regular arrangement of grid cells, where the size of the largest possible sub-hologram determines the size of the grid cells. A grid cell comprises multiple pixels both in the vertical and in the horizontal direction.

A phase-modulating light modulator can be a preferred embodiment of the light modulator means.

Each sub-hologram can for example be represented on the phase-modulating light modulator as a lens function in one grid cell, and the luminous intensity of a reconstructed object point can be controlled by providing that lens function which represents the sub-hologram in the grid cell for a variable period of time T2. Outside the sub-hologram, a linear phase function is then provided in the grid cell during the period of time T2, in which no lens function is provided, said phase function deflecting the light to a position outside the visibility region. With the help of this feature of the present invention, it is achieved that an object point is reconstructed with its real luminous intensity. If the limitations regarding the hologram reconstruction are accepted, the phase-modulating light modulator can be a binary modulator. In a further preferred embodiment, the phase-modulating light modulator is a modulator which is capable of controlling few, but at least three phase levels.

In another embodiment, the light modulator means can comprise a combination of a phase-modulating light modulator and an amplitude-modulating light modulator. The amplitude-modulating light modulator here preferably serves to write to a grid cell a frame which limits the extent of a sub-hologram and which exhibits a minimum transmittance between the sub-hologram and the edge of the grid cell.

Both the phase-modulating and the amplitude-modulating light modulator can be binary modulators in this embodiment.

In a still further preferred embodiment, the phase-modulating light modulator is capable of controlling few, but at least three phase levels.

If only the amplitude-modulating light modulator is a binary modulator, the luminous intensity of a reconstructed object point is controlled in that the amplitude-modulating light modulator is switched transmissive in the region of a sub-hologram for a variable period of time T2.

The device is further designed such that the illumination system has at least one light source for illuminating at least one grid cell of the light modulator means, where the luminous intensity of the light source is controllable in order to be able to vary the temporally averaged luminous intensity of the reconstruction of individual object points.

In the device, the grid, which is controlled by software means in the first processor element, is displaced by at least one pixel of the light modulator means but by no more than one grid cell in order to generate new object point groups and to generate further common holograms. Thereby, a partial reconstruction of the 3D scene is generated from each encoded object point group. For a two-dimensional code, the displacement of the grid is realised both in the horizontal and vertical direction by maximal one grid cell.

The present invention further relates to a holographic display for reconstructing a three-dimensional scene with an illumination system for illuminating a spatial light modulator means with sufficiently coherent light, which is modulated with holographic information of the encoded three-dimensional scene (3D scene), and which is projected by a projection system to an eye position in a visibility region, from where the reconstruction of the 3D scene is visible in a frustrum-shaped reconstruction space, which stretches between the light modulator means and the visibility region, for at least one observer eye, whose position is detected by a position finder, which is combined controlled by software means with a processor for computing and encoding holograms of the 3D scene, where the display uses a selection process for encoding the 3D scene which is divided into object points, as set forth in the method claims, which is characterised in that
A first processor element, which is controlled together with the light modulator means, is provided for generating on the light modulator means a displaceable two-dimensional grid with regularly arranged grid cells, in which common holograms of the 3D scene are encoded, which comprise sub-holograms which are computed according to the selection process and which are simultaneously encoded in the horizontal and/or vertical direction, and which represent partial reconstructions of the 3D scene, where one sub-hologram is always encoded in one grid cell, and
A second processor element is provided, which controls the illumination system in synchronism with the displacement of the grid on the light modulator means, for sequentially generating other partial reconstructions of the 3D scene which are resulting from a displacement of the grid, which are intrinsically coherent, but mutually incoherent, and whose wave fronts, which are modulated with holographic information, are sequentially superposed in the visibility region, and which can be seen from the eye position as a single, temporally averaged reconstruction of the 3D scene.

Now, the method according to this invention and the corresponding device will be described in detail with the help of accompanying Figures, wherein

FIG. 1a is a top view showing schematically object points of a 3D scene and their encoded sub-holograms (prior art),

FIG. 1b shows schematically two-dimensional sub-holograms which are encoded on the light modulator means, according to FIG. 1a, but seen from the observer's,

FIG. 1c shows schematically one-dimensional HPO sub-holograms which are encoded on the light modulator means, for the object points according to FIG. 1a, again seen from the observer's,

FIG. 2 shows the frequency of individual amplitudes of overlapping sub-holograms which occur in a hologram, with the dynamic range (prior art),

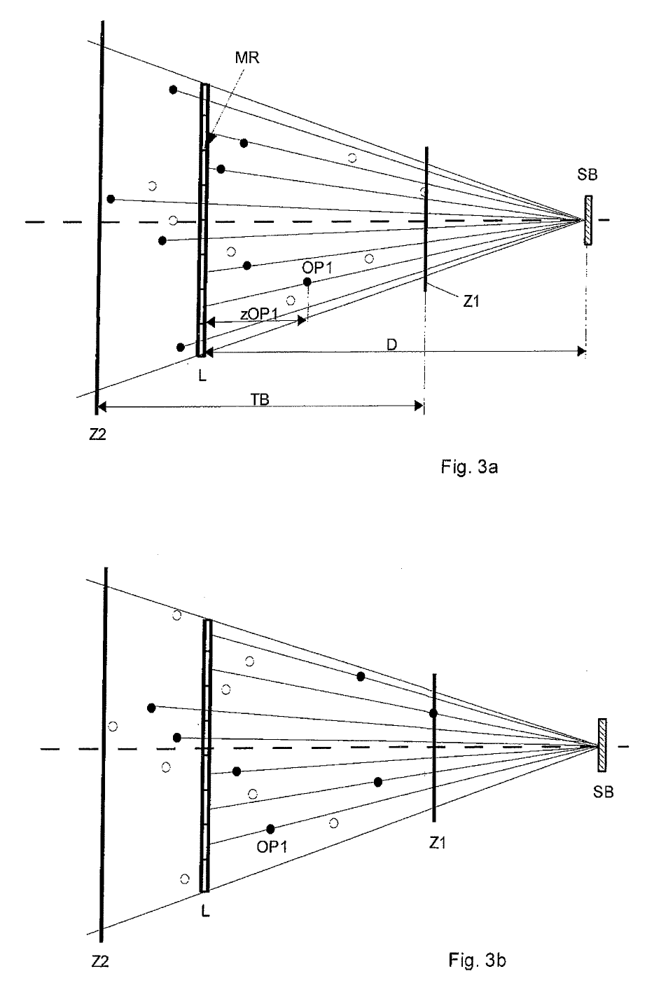

FIG. 3a is a top view which shows a defined depth range with object points which form an object point group,

FIG. 3b is a top view which shows a defined depth range with object points which form a different object point group,

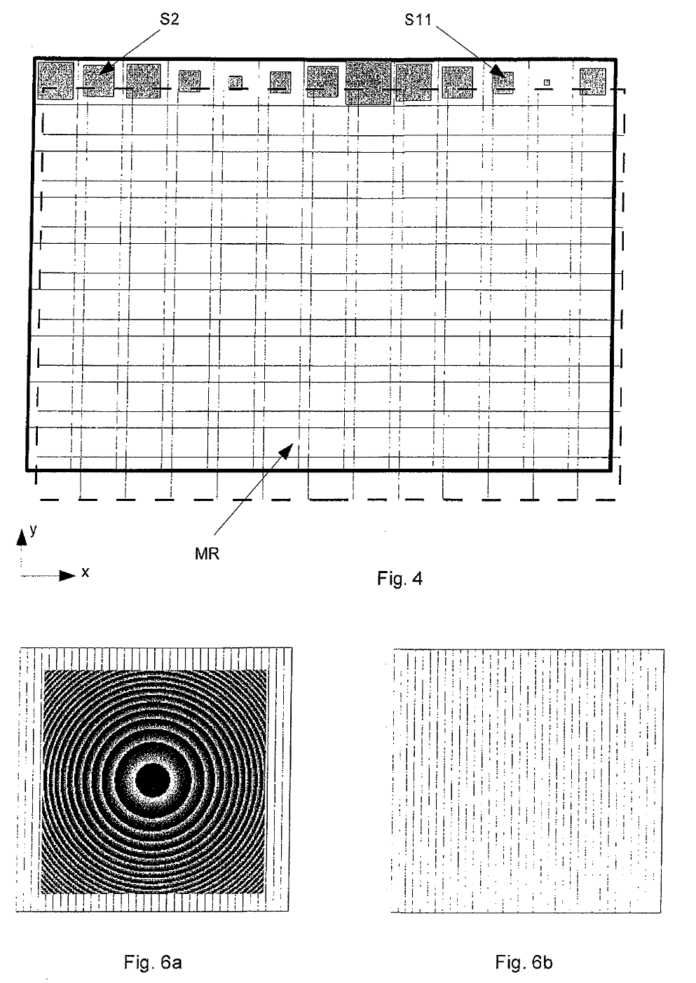

FIG. 4 shows a grid with encoded sub-holograms in a hologram for a partial reconstruction, including an overlapping displacement of the grid,

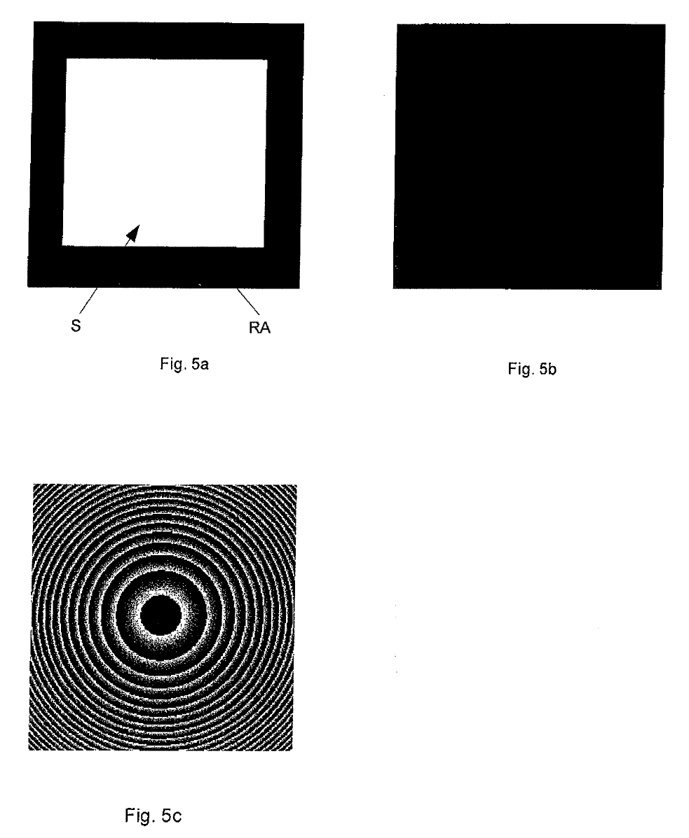

FIG. 5 shows schematically examples of holograms encoded on a light modulator combination,

FIG. 6 shows schematically examples of holograms encoded on a single light modulator,

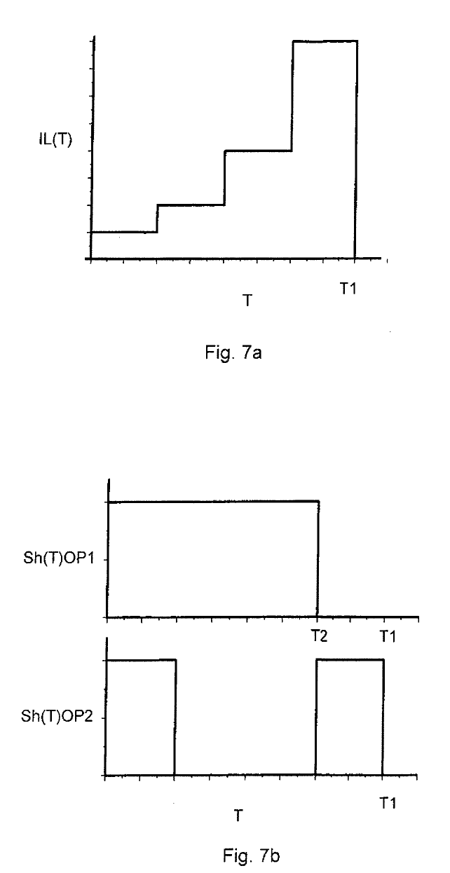

FIG. 7a shows the luminous intensity control of a light source over an period of time T1, and

FIG. 7b shows two sub-holograms for two object points which are reconstructed at different times.

The device for implementing the method according to the present invention, i.e. the holographic representation of 3D scenes, comprises in addition to illumination means, modulator means and reconstruction means, processor means and control means for carrying out controlled by software means the corresponding process steps up to the reconstruction of the 3D scene.

Referring to FIG. 1c, the encoded sub-holograms S1, S2 and S3 which correspond to the three object points OP1 to OP3 of a 3D scene are represented as a one-dimensional HPO (horizontal parallax only) encoding as can be seen from the eye position of an observer. The representation is based on FIGS. 1a and 1b, which were explained in the prior art section above.

A sub-hologram always lies centrally in relation to the corresponding object point, where here only the object point OP3 is indicated exemplarily. An observer whose eye pupil is situated in the centre of the observer window sees the object point in the centre related to the surface area of the corresponding sub-hologram. In the case of HPO encoding, the sub-holograms S1 to S3 only have the vertical extent of a single row in the light modulator means L. Since they are encoded in different rows because of their position in the 3D scene, they do not overlap. Only sub-holograms within the same row can overlap if a HPO encoding process is used. In overlapping sub-holograms, the luminous intensities or information are normally superimposed in adjacent pixels of a modulator region.

The method according to the present invention and the means required for its implementation will now be described in more detail with the help of FIGS. 3 and 4.

FIGS. 3a and 3b show how certain object points OPn are selected for representing an object point group OPGm in a hologram, according to the method according to the present invention.

FIG. 3a is a top view showing a spatial depth range TB, in which the 3D scene is to be reconstructed, and which is defined by two planes Z1 and Z2. A sub-hologram S may become large, if the corresponding object point OP is located very close in front of the visibility region SB. In order to avoid this, the depth region TB is defined accordingly. The plane Z1 confines the 3D scene in front of the screen, and the plane Z2 confines the 3D scene behind the screen. The depth range TB comprises a multitude of object points OPn, of which one is marked exemplarily as OP1. The object point OP1 has a distance zOP1 to the light modulator means L, which is disposed at a distance D to the visibility region SB. The depth range TB lies within a reconstruction space, which typically stretches as a frustrum between the visibility region SB and the light modulator means L. However, the 3D scene to be reconstructed, which is divided into object points OPn, here continues beyond the light modulator means L. The light modulator means L is assigned with a displaceable grid MR with a regular two-dimensional arrangement of grid cells. Auxiliary rays, which originate in the centre of the visibility region SB, serve to associate object points OPn and grid cells of the grid MR. Only those object points which form an object point group are marked as black dots.

In FIG. 3b the grid MR was displaced by at least one pixel. The object points OPn which are now to be reconstructed in the depth range TB are shown is a shifted grid position compared to FIG. 3a. As an effect of the displacement, another object point group OPG is formed with other object points OPn, which are also marked black.

A first processor element PE1 (not shown) generates a grid MR for the screen and combines all object points OPn in the depth range TB which lie axially on an auxiliary ray and centrally in relation to a grid cell at a certain time, thus forming an object point group OPGm. The depth range TB is defined in the axial direction such that a maximum possible surface area of a sub-hologram S does not exceed the surface area of a grid cell. A grid cell thus has a grid width and grid height which corresponds to the maximum width and height of the largest sub-hologram S of the object point group. The grid cell comprises multiple, horizontally and vertically adjacent or, in a subsequent third embodiment with HPO encoding, only horizontally adjacent pixels of the light modulator means L.

The central position of each object point OP in the depth range TB in relation to a grid cell of the generated grid MR is defined as a criterion for forming object point groups OPGm. The central position is detected with the help of auxiliary rays, which originate in the centre of the visibility region SB and run to the light modulator means L, and there through the centre of the grid cells or their projections. All object points OPn which lie on such a ray form an object point group OPG.

As described in document (2), object points OPn can for example be assigned according to their index in the point matrix, which is defined during the division of the 3D scene into section layers, so to form object point groups OPGm. The arrangement in groups can be realised such that the index of any object point OP in the point matrix of the corresponding section layer complies with the pixel index in the centre of a grid cell on the light modulator means L.

A sub-hologram S is computed for each object point OP of the object point group OPG which has been generated with this process step and encoded separately in one grid cell each. Since their encoding takes place simultaneously, the sub-holograms represent the common hologram of the respective object point group OPG. Thanks to the generation of object point groups OPGm, it is achieved in a preferred manner that sub-holograms Sn do not overlap so that the object points reconstruct the 3D scene in an unbiased fashion.

For encoding the holograms, a light modulator means L is used which exhibits a sufficiently fast switching speed for the sequential representation of the holograms.

FIG. 4 shows schematically the surface area of a light modulator means L with the grid MR for simultaneous two-dimensional full parallax (FP) encoding of multiple sub-holograms Sn, which do not overlap, in a direct view-display. The sub-holograms S2 and S11 are indicated exemplarily in FIG. 4. The grid MR is generated by software means in a first processor element PE1. ‘Generated by software means’ means that a given programme is run on a computer.

In a projection display, a screen, for example in the form of a mirror element, is disposed at the position of the light modulator means L, onto which the information of the holograms of the individual object point groups OPGm is sequentially projected.

Several sub-holograms Sn with different sizes are shown exemplarily in the upper row. The sub-holograms Sn lie centrally in a grid cell MR, analogously to the central position of the object points OPn in the sub-holograms. Depending on the axial distance of a corresponding object point OP to the screen, the sub-hologram S is either smaller than or maximal as large as the grid cell. Individual grid cells or regions with grid cells of the grid MR also remain empty if the 3D scene to be reconstructed does not have any object points OPn at the corresponding position in the depth range TB.

In order to encode further sub-holograms Sn of other object points OPn or further common holograms of object point groups OPGm of the 3D scene, the generated grid MR is controlled by software means to be displaced by at least one pixel of the light modulator means L or, in adaptation to the resolution of the 3D scene, also by multiple pixels. Then, other sub-holograms Sn, which do not overlap, can be computed and represented on the light modulator means L within a very short time. FIG. 4 illustrates the displacement of the grid MR with the help of broken lines. As an effect of the displacement, other object points OPn of the 3D scene are determined according to their distance to the centre of a grid cell, and their sub-holograms Sn of the 3D scene are simultaneously re-encoded on the light modulator means L. The grid MR will be displaced in the horizontal and vertical direction until the grid is displaced by an entire grid cell.

If the displacement by one grid cell in the grid MR is completed for the given number of pixels, all object points OPn of the 3D scene in the depth range TB will be entirely detected, computed and encoded. This method of computing and encoding non-overlapping sub-holograms Sn allows the 3D scene to be fully reconstructed in the reconstruction space from the sequentially generated partial reconstructions.

A second processor element PE2 controls at least one light source of the illumination system in synchronism with the displacement of the grid MR on the light modulator means L. The light which is modulated with the actually encoded hologram creates a respective partial reconstruction of the 3D scene. Intrinsically coherent, but mutually incoherent partial reconstructions are generated at a fast pace from the multitude of sequentially encoded common holograms and superposed sequentially in the visibility region SB. The observer then sees from its eye position AP a single, temporally averaged reconstruction of the 3D scene.

The size of a sub-hologram S, expressed in the form of the number of pixels of the used light modulator means L, is computed using the following equation:

np_{x,y}=|z/(D−z)|*Dλ/p_{x,y}² (1)

where z is the axial distance between an object point OP of the 3D scene and the light modulator means L or a screen, D is the distance from the visibility region SB to the light modulator means L or the screen, and λ is the wavelength of the light emitted by the light source used. Further, the width (pₓ) or the height (p_{y}) of a macro pixel of the light modulator means L or, in a projection display, of the macro pixel displayed on the screen must be inserted for p_{x,y}.

In a sub-hologram S, the number of macro pixels in the horizontal direction (width) is obtained when inserting npₓ, and the number of macro pixels in the vertical direction (height) is obtained when inserting np_{y}. A macro pixel is either a single pixel or a group of adjacent pixels to which a complex value is written.

According to equation (1), the maximum sub-hologram size is defined by the maxima of the two values np_{x,y}(Z1) and np_{x,y}(Z2). According to the present invention, it is possible in this case to introduce a fix grid MR with a spacing that corresponds to that maximum sub-hologram size. Multiple object points OPn can thus be represented simultaneously with this grid spacing on the light modulator means L, without overlapping of their sub-holograms Sn.

The above-mentioned dynamic range of the amplitudes is to be taken into consideration when encoding the sub-holograms Sn. The dynamic range results from the different luminous intensities of the object points OPn to be reconstructed and the different axial distance of the individual object points OPn to the visibility region. Both causes different amplitudes in the sub-holograms Sn.

The different luminous intensities of individual object points OPn to be reconstructed and also the different amplitudes of the sub-holograms Sn can be represented more precisely by a intensity control of the light sources of the illumination system. To achieve this, the individual object point OP is reconstructed for a variable period of time, controlled by software means in the processor element PE2. The observer eye averages the brightness over the time during which that object point OP is visible. This procedure becomes possible because the sub-holograms Sn of the object points OPn do not overlap and thus each sub-hologram S can be presented separately for a variable period of time compared to the other sub-holograms Sn. This has the advantage that light modulators with a low bit depth can be used for implementing the method without a decline in the reconstruction quality of the 3D scene. This will be explained in an exemplary manner in the description of FIG. 7.

The method is particularly preferably applied to an HPO encoding method. Therein, each single modulator row comprises independent values, so that a grid MR with a grid spacing can be used whose maxima npₓ (Z1) or npₓ (Z2) are defined by the equation (1). The grid height here is the height of a single row of the light modulator means L. A very large number of object points OPn can thus be represented simultaneously. Less consecutive holograms must thus be encoded in order to represent the 3D scene. The demands made on the representation speed or switching speed of the light modulator means L to be used are thus reduced.

In a first embodiment of the device, the method is realised according to the present invention with the help of a combination of an amplitude-modulating light modulator and a phase-modulating light modulator, to which the complex hologram values are written. Therein, the lens function for the reconstruction of an object point OP is encoded on the phase-modulating light modulator, and a frame RA, which limits the sub-hologram S, and the luminous intensity of the object point OP to be reconstructed are encoded on the amplitude-modulating light modulator. Both the amplitude-modulating light modulator and the phase-modulating light modulator can preferably be binary modulators. The phase-modulating light modulator can alternatively be a modulator which allows at least three phase levels to be controlled.

If at least the amplitude-modulating light modulator is a binary modulator, it will generally limit the size of a sub-hologram S. This means that the regions between the edge of the grid cell and the edge of the sub-hologram S do not transmit light and are shown in black.

FIG. 5a shows this for a sub-hologram S, where the sub-hologram S exhibits a black frame RA as a result of the encoding process. The entire grid cell is represented for a certain period of time T1, and the sub-hologram S is represented in the period of time T2.

Depending on the axial distance of the object point OP to the eye position AP, the frame RA of the sub-hologram S is more or less wide, so more or less blocking the light accordingly, while the central region of the grid cell is switched to the transmissive mode.

For a binary amplitude-modulating light modulator, the transmittance in the central region is controlled in analogy with the above-described pulse width modulation (PWM).

The entire surface area of the grid cell can be black for a period of time T1-T2, as shown in FIG. 5b. This means that no object point OP of the 3D scene is provided in the grid at that time.

In an embodiment of the present invention, the phase-modulating light modulator can also be a binary modulator. As is commonly known, the phase function of a lens can be represented as binary phase plot in the form of a Fresnel zone plate.

FIG. 5c shows an example for a phase plot as it is displayed on the phase-modulating light modulator as a lens function in order to represent an object point OP. The lens function must be displayed at least for the period of time T2, but can also be displayed for the entire period of time T1 without any disadvantages. The lens function must necessarily be represented in the central region of the grid cell, which is switched to the transmissive mode on the amplitude-modulating light modulator, as shown in FIG. 5a.

Phase-modulating light modulators which are capable of controlling few, but at least three phase levels are preferably used to encode multiple phase values.

Alternatively, the lens function can be encoded directly on the amplitude-modulating light modulator.

The process steps of the encoding and reconstructing are based on the following characterising features in all embodiments:

A 3D video, which is displayed on a holographic display device, comprises a multitude of 3D scenes (individual images). A 3D scene is reconstructed within a period of time T0, where the period of time shall preferably be 1/25 seconds. The sub-holograms Sn of an object point group OPG, which is generated by a first processor element PE1, are each displayed simultaneously and reconstruct that object point group OPG in a period of time T1. If the entire 3D scene comprises n different object point groups, T1 will be approximately equal to T0/n.

The luminous intensity of an object point OP to be reconstructed is represented in that the central region of a grid cell, corresponding to the sub-hologram S, comprises complex values for the reconstruction of the object point OP for a certain period of time T2 (T2<=T1), but does not comprise any values for the remaining period of time T1-T2, so that the object point is not reconstructed.

In the first embodiment, there is thus a maximum transmittance for the period of time T2 and a zero transmittance for the period of time T1-T2 in the amplitude-modulating light modulator. Near the maximum transmittance, illuminated pixels of the amplitude-modulating light modulator are then activated by the illumination system.

The phase-modulating light modulator is controlled by software means to simultaneously display the phase plot of the corresponding sub-hologram S within the period of time T1. In all embodiments, the period of time T2 is different for each single sub-hologram S within the grid MR, because it depends on the luminous intensity and the distance of each object point OP to be reconstructed to the grid MR.

The adjustment of the amplitude-modulating light modulator to the phase-modulating light modulator need not to be carried out that precisely compared to the known methods which involve a combination of two light modulators for representing complex values. There, the modulators must be aligned with the precision of fractions of the pixel size. Each offset between the pixels causes incorrect complex values to be represented and the reconstruction quality to be deteriorated. In contrast, in the embodiment according to this invention, a slightly lateral maladjustment by parts of one pixel only causes an incorrect sub-hologram aperture. The position of the sub-hologram S is then displaced by about few percentage points, which, however, does not have any negative effects, because it equally affects all sub-holograms Sn.

In a second embodiment, a single phase-modulating light modulator is used to write hologram values. As is generally known, at least two pixels are used for representing a hologram value on a phase-modulating light modulator.

FIG. 6a shows the object point OP as a lens function for the period of time T2, limited to the size of the sub-hologram S in a grid cell. Outside the sub-hologram S, a linear phase plot, for example alternately the phase values 0 and π, is written to adjacent pixels for a period of time T1, thus causing light of those pixels to be deflected out of the visibility region SB. The sub-hologram S is thus represented correctly as regards its size and luminous intensity.

In contrast, FIG. 6b shows a linear phase plot, which is applied over the entire grid cell MR, for a period of time T1-T2. The entire light for this grid cell does not enter the visibility region SB, but is deflected away from it.

Within a sub-hologram S, the same complex phase value is always written to two adjacent pixels for example for a period of time T2<=T1; however, over the entire sub-hologram S, the phase plot which corresponds to the lens function of the corresponding object point OP is written. In that period of time T2, the object point OP is reconstructed by the illumination system, where the illumination system is controlled by the second processor element PE2. During the period of time T1-T2, the phase plot which deflects the light of those pixels away from the visibility region SB is encoded on the sub-hologram S again, as described above, so that no reconstruction is realised in that period of time T1-T2.

In a hologram with individual non-overlapping sub-holograms Sn, object points OPn are reconstructed correctly as long as the phase of the sub-holograms Sn is represented correctly. The temporally averaged visible luminous intensity of reconstructed object points OP can be controlled for an observer in that, analogously to the pulse width modulation, the corresponding sub-holograms Sn are displayed on the light modulator for a variable period of time.

The object point OP is then reconstructed correctly each time its sub-hologram S is displayed. In contrast, no reconstruction will be realised each time the sub-hologram S is not displayed.

The advantage of this embodiment is that the iterative computation can be omitted, in contrast to the phase encoding method for overlapping sub-holograms, as described in the prior art.

The iterative computation is required in the prior art methods, because a greater dynamic range is formed as an effect of different sub-holograms being added. The representation of different amplitudes in a phase encoding method here causes errors.

In contrast, according to the inventive method a single sub-hologram S comprises a lens function with an absolute value which is roughly constant across the sub-hologram S. The sub-hologram S can thus be encoded directly as phase function without errors.

Another advantage is the possibility in a holographic display to only use one light modulator, which must just comprise a larger number of pixels than in the first embodiment due to the phase encoding method. The demands on the switching speed of the phase-modulating light modulator are higher, but feasible.

In both embodiments, in addition to the normal phase width modulation, the luminous intensity of the illumination system can be controlled variably. The illumination system may comprise multiple light sources.

Referring to FIG. 7a, T1 shows a period of time T1 during which additionally the luminous intensity of at least one light source which illuminates the light modulator means L is varied, while at the same time during the period of time T2 (see FIG. 7b) individual illuminated object points OPn are reconstructed.

IL(T) is the luminous intensity of the light source depending on the time T in FIG. 7a, and Sh(T)OP1 and Sh(T)OP2 in FIG. 7b are functions which take the value 1 at the times when an object point OP1 and OP2, respectively, is reconstructed on the light modulator means L with the help of a lens function, and which take the value 0 at the times when the object point OP1 and OP2, respectively, is not reconstructed. Then, the temporally averaged luminous intensity with which an observer perceives the respective object point OP is proportional to the integral of the product of IL(T) and Sh(T)OP during the period of time T1.

This means in practice that the period of time T1 can typically be divided into M fix sub-periods of time for a given switching speed of the light modulator means L. For a constant luminous intensity of the light source IL(T)=const, thus only M different levels of intensity can be realised in the reconstruction. However, if the light source IL(T) is varied during the period of time T1, a larger number of different levels of luminous intensity can thus be represented with the same switching speed of the light modulator means L. FIG. 7a shows this schematically for the case M=4. The luminous intensity of the light source doubles during the course of four periods of time with the length T1/4.

The object points OP1 and OP2 of two different sub-holograms S1 and S2 are only reconstructed during individual periods of time, as shown in FIG. 7b. Referring to FIG. 7b, the object point OP1 of the sub-hologram S1 is reconstructed during the periods of time 1 to 3, while the other object point OP2 is reconstructed during the periods of time 1 and 4.

The relative luminous intensity of the object point OP1 is then proportionally 1*1+1*2+1*4+0*8, and that of object point OP2 it is proportionally 1*1+0*2+0*4+1*8.

This way, by dividing the period of time T1 into four sub-periods of time, according to FIG. 7a, and correspondingly varying the light source intensity as 2⁰, 2¹, 2², 2³, a total of 16, i.e. 2⁴, different levels of luminous intensity can be realised for the reconstruction of a single object point OP. More generally, for k sub-periods of time and the variation of the light source intensity as 2⁰, . . . 2^{k-1}, there are a total of 2^{k} levels of luminous intensity.

The period of time T1 can for example also be divided into k identical sub-periods of time, and the luminous intensity of the light source can be controlled relative to a reference value in the first sub-period by a factor of 2 to the power of (k−1), in the second sub-period by a factor of 2 to the power of (k−2) and in the k^{th} sub-period by a factor of 2 to the power of 0, i.e. 1. Then, 2 to the power of k different levels of luminous intensity can be represented in k sub-periods of time.

Both embodiments can be combined with the HPO and FP encoding method. However, if the hologram is represented with the help of the HPO encoding method, the grid cells of the grid MR are covered in a single hologram row only. The 3D scene can thus be divided into a smaller number of larger object point groups OPGm, and an observer sees a reconstruction which is temporally averaged over few partial reconstructions. The grid MR must only be displaced row by row. Altogether, this embodiment has the advantage that it causes the least computational load while the reconstruction result compares to the preceding embodiments, and that at the same time the lowest demands are made on the switching speed of the light modulators to be used.

The HPO encoding method will be explained in detail below with the help of a numerical example for a maximum sub-hologram size of 32 macro pixels:

The grid cells are generally displaced in steps of one macro pixel for encoding the sub-holograms Sn of the object points OPn.

In this example, the 3D scene is thus divided into a total of 32 groups of object points OPn, from which 32 holograms are computed, encoded and sequentially represented, so that an observer is able to see their temporally averaged reconstructions from the visibility region.

For a representation of a video with for example 25 images per second, all 32 holograms must be represented within 40 ms, i.e. one hologram within about 1.25 ms.

In a combination of an amplitude-modulating and a phase-modulating light modulator, the phase-modulating light modulator must have that refresh rate or smaller.

The amplitude-modulating light modulator for the pulse width modulation of luminous intensities could for example exhibit a refresh rate which is eight times faster, i.e. about 150 microseconds. Ferro-electric liquid-crystal displays with switching times of 40 microseconds are for example suitable to achieve this.

For FP encoding, there would be an extent of the sub-holograms Sn in two dimensions. This requires either the sequential representation of more holograms, i.e. faster light modulators. Or the resolution of the 3D scene is reduced if fast light modulators are not available.

If a sub-hologram for example has a maximum size of 32*32 macro pixels, and if the resolution of the object points is reduced by a factor of 4 in both dimensions, the grid can be displaced in steps of four macro pixels. This results in a total of 8*8, i.e. 64, holograms which are represented one after another. The demand made on the refresh rates of the light modulators only increases by a factor of 2, compared to the above-mentioned numbers.

The following advantages result for the encoding examples:

The sequential partial reconstruction of the object point groups OPGm causes no disadvantages regarding the luminous intensity of the reconstruction of the 3D scene.

The 3D scene is divided into n groups of object points OP in a reconstruction with sub-holograms Sn which do not overlap. A partial reconstruction, which results from each object point group OPG, is only represented for the period of time T1=T0/n and an object point OP is also only reconstructed for this period of time at maximum. However, all pixels of the sub-hologram S can contribute to the reconstruction of this object point OP with their entire luminous intensity within this period of time.

In contrast, pixels of overlapping sub-holograms contribute with their luminous intensity to the reconstruction of multiple object points.

In this method, light modulator means can also be used which have few luminous intensity or phase levels, e.g. three, four or eight.

This document describes a method of temporal averaging of intrinsically coherent, but mutually incoherent partial reconstructions which are generated at a fast pace, in order to render the reconstruction of the entire 3D scene visible. Because disturbing speckle patterns can also be reduced using this principle, the method according to the present invention also positively affects the reconstruction quality, because the speckle patterns are reduced.

Summarising, the present invention boasts the following advantages compared with the prior art:

Because a depth range is given in the reconstruction space for the scene to be reconstructed, the maximum size of a sub-hologram of an object point is limited. The sub-holograms of all object points need thus not be computed and represented one after another, but a certain number of sub-holograms can instead be represented simultaneously at the distance of the maximum size of a sub-hologram.

Holograms with a small dynamic range can be encoded on the light modulator means. Quantification errors and other disadvantages, which are caused by the overlapping of multiple sub-holograms of object points of a 3D scene, are here prevented.

In a holographic display, optionally either a combination of multiple light modulators can be used for encoding the hologram values, without the above-described disadvantage of the precise adjustment, or a single light modulator, preferably a phase-modulating light modulator, without the disadvantage of an iterative computation.

Further, faster light modulators with small bit depth, i.e. binary light modulators, can be used thanks to the this method. The computational load for hologram computations can be reduced and the total computing time can be minimised.

1. Method for reconstructing a three-dimensional scene in a holographic display,
where the three-dimensional scene (3D scene) is divided into individual object points, where each object point is encoded as a sub-hologram on a spatial light modulator means, which is illuminated with sufficiently coherent light by light sources of an illumination system,
where the 3D scene is reconstructed within a reconstruction space, which stretches between a visibility region and a screen, from reconstructed wave fronts of the object points, where the reconstruction is visible for at least one observer eye in a position which is situated in the visibility region,
and where a processor comprises processor elements for computing and encoding the 3D scene, wherein
A first processor element
Generates on the light modulator means a displaceable, two-dimensional grid with regularly arranged grid cells for encoding the sub-holograms,
Selects object points depending on the set positions of the grid cells and aggregates them to form object point groups, and
Simultaneously computes the sub-holograms of the object points of a generated object point group and simultaneously encodes them as a common hologram of the object point group in a separate grid cell on the light modulator means, where the common holograms of all object point groups are encoded sequentially, and
A second processor element controls the illumination system in synchronism with the displacement of the grid on the light modulator means such that intrinsically coherent but mutually incoherent partial reconstructions of the object point groups are generated from the multitude of sequentially encoded holograms at a fast pace and superposed sequentially in the visibility region.

2. Method according to claim 1, wherein the first processor element defines in the reconstruction space a depth range, which is confined by two planes, which comprises all object points which contribute to the reconstruction of the 3D scene, and which defines the surface area of their sub-holograms on the light modulator means.

3. Method according to claim 2, wherein the maximum surface area of a single sub-hologram is defined by the axial distance of one of the two planes of the given depth range from the plane of the visibility region or where the depth range is limited to a maximal axial distance in front of and, optionally, behind the light modulator means.

4-5. (canceled)

6. Method according to claim 2, wherein the first processor element forms an object point group by selecting object points from the defined depth range depending on their spatial position to a grid cell of the generated grid, and by combining them in an object point group.

7. Method according to claim 6, wherein only those object points which lie in a certain position of the generated grid, centrally in relation to a grid cell, form an object point group.

8. Method according to claim 6, wherein the first processor element is controlled by software means to displace the grid by at least one pixel in a pixelated light modulator means in order to compute and encode the common hologram of a further object point group.

9. Method according to claim 8, wherein the first processor element displaces the grid horizontally in order to encode a one-dimensional hologram, and both horizontally and vertically in order to encode a two-dimensional hologram.

10. Method according to claim 9, wherein the sub-holograms of an object point group are simultaneously encoded in the horizontal and vertical direction on the light modulator means in the case of two-dimensional encoding and where the grid is displaced in the horizontal and/or vertical direction by maximal one grid cell each, where all different positions of object points in the depth range are covered.

11. (canceled)

12. Method according to claim 1, wherein the size of a sub-hologram (S) is computed according to the equation
npx,y=|z/(D−z)|*Dλ/px,y2 (1),
where z is the axial distance between an object point and the light modulator means or a screen, D is the distance of the visibility region from the light modulator means or a screen, λ is the wavelength of the light of a light source used in the illumination system, and p_{x,y} is the width (pₓ) or height (p_{y}) of a macro pixel.

13. Method according to claim 1, wherein a position finder detects the current eye position of an observer eye and a position controller controls the direction of propagation of the modulated wave fronts of the sub-holograms such that they are directed at the current eye position.

14. Method according to claim 1, wherein a sub-hologram is encoded in one dimension or in two dimensions in adjacent pixels of a grid cell of the light modulator means.

15. Method according to claim 12, wherein the light modulator means, on which the sub-hologram is encoded, serves as a screen, where the light modulator means is preferably a transmissive light modulator or where the screen is an optical element onto which a hologram encoded on the light modulator means, or a wave front of the 3D scene encoded on the light modulator means, is projected.

16. (canceled)

17. Method according to claim 15, wherein the light modulator means is optionally a transmissive or a reflective light modulator.

18. Method according to claim 1, wherein a temporally averaged visible luminous intensity of object points is controlled by reconstructing the object points for variable periods of time.

19. Method according to claim 18, wherein additionally the luminous intensity of at least one light source of the illumination system, which illuminates the entire light modulator means or only individual grid cells thereof, is temporally varied.

20. Device for reconstructing a three-dimensional scene
with an illumination system comprising at least one light source which emits sufficiently coherent light, for illuminating at least one spatial light modulator means,
with reconstruction means for reconstructing the three-dimensional scene (3D scene) which is divided into individual object points, within a reconstruction space which is stretched between the light modulator means and a visibility region, where the reconstruction is visible from an eye position in the visibility region, and
with a processor with processor elements for computing and encoding sub-holograms of the object points of the 3D scene,
for implementing the method according to claim 1, wherein
A first processor element is provided for generating a displaceable, two-dimensional grid with regularly arranged grid cells on the light modulator means, for defining a depth range in the reconstruction space, for generating object point groups from the object points of the 3D scene, for computing a multitude of sub-holograms of the object points of a generated object point group, and for simultaneously encoding the sub-holograms as a common hologram of the respective object point group in a separate grid cell each, where the common holograms of all object point groups are encoded sequentially, and
A second processor element is provided for controlling the illumination system in synchronism with the displacement of the grid on the light modulator means such that intrinsically coherent but mutually incoherent partial reconstructions of the object point groups are generated from the multitude of sequentially encoded holograms at a fast pace and superposed sequentially in the visibility region.

21. Device according to claim 20, which is preferably a holographic display in the form of a direct-view display or a projection display.

22. Device according to claim 21, wherein the light modulator means directly serves as a screen, or where the device comprises a screen onto which images of the information of the 3D scene which is holographically encoded on the light modulator means are projected.

23. Device according to claim 20, wherein a grid cell comprises a region of multiple horizontally and vertically adjacent pixels, or where the surface area of a grid cell corresponds with the surface area of the largest possible sub-hologram.

24. Device according to claim 21, wherein the light modulator means is a phase-modulating light modulator, which is capable of controlling at least three phase levels.

25. (canceled)

26. Device according to claim 24, wherein a sub-hologram is represented on the phase-modulating light modulator as a lens function in a grid cell, and where the luminous intensity of a reconstructed object point can be controlled by representing that lens function in the sub-hologram for a variable period of time.

27. Device according to claim 24, wherein a linear phase function is represented in the boundary areas of a grid cell on the phase-modulating light modulator, said phase function deflecting the light to a position outside the visibility region.

28. Device according to claim 26, wherein for the period of time during which no lens function is represented a linear phase function is represented in the grid cell, said phase function deflecting the light to a position outside the visibility region.

29. Device according to claim 21, wherein the light modulator means is a binary phase-modulating light modulator or comprises a combination of a phase-modulating light modulator and an amplitude-modulating light modulator.

30. (canceled)

31. Device according to claim 29, wherein the amplitude-modulating light modulator is a binary modulator, and where the temporally averaged visible luminous intensity of a reconstructed object point will be controlled in that the amplitude-modulating light modulator is switched to a transmissive mode in the region of a sub-hologram for a variable period of time.

32. Device according to claim 31, wherein a frame, which limits the extent of a sub-hologram, and which exhibits a minimum transmittance, is written to a grid cell of the amplitude-modulating light modulator, more precisely between that sub-hologram and the edge of the grid cell.

33. Device according to claim 29, wherein the phase-modulating light modulator is of a binary type or is capable of controlling at least three phase levels.

34. Device according to claim 20, wherein one or multiple light sources are provided in an illumination system for illuminating at least one grid cell of the light modulator means, where the luminous intensity of said light source is controllable in order to control the temporally averaged luminous intensity of the reconstruction of individual object points.

35. Device according to claim 20, wherein a partial reconstruction of the three-dimensional scene is generated from an encoded object point group.

36. Device according to claim 20, wherein the grid is controlled by software means to be displaced by at least one pixel of the light modulator means but by maximal one grid cell, in order to encode a different hologram, which comprises different sub-holograms, where the grid is displaced both horizontally and vertically for a two-dimensional encoding.

37. Holographic display for reconstructing a three-dimensional scene with an illumination system for illuminating with sufficiently coherent light a spatial light modulator means, which modulates the light with holographic information of the encoded three-dimensional scene (3D scene), and with a projection system which projects the light to an eye position in a visibility region, from where the reconstruction of the 3D scene is visible in a frustrum-shaped reconstruction space, which stretches between the light modulator means and the visibility region, for at least one observer eye, whose position is detected by a position finder, which is combined controlled by software means with a processor for computing and encoding holograms of the 3D scene, where the display uses a selection process for encoding the 3D scene which is divided into object points, as set forth in claim 1, and wherein
A first processor element, which is controlled together with the light modulator means, is provided for generating on the light modulator means a displaceable two-dimensional grid with regularly arranged two-dimensional grid cells, in which common holograms of the 3D scene are encoded, which comprise sub-holograms which are computed according to the selection process and which are simultaneously encoded in the horizontal and/or vertical direction, and which represent partial reconstructions of the 3D scene, where one sub-hologram is always encoded in one grid cell, and
A second processor element is provided, which controls the illumination system in synchronism with the displacement of the grid on the light modulator means, for sequentially generating other partial reconstructions of the 3D scene which are resulting from a displacement of the grid, which are intrinsically coherent, but mutually incoherent, and whose wave fronts, which are modulated with holographic information, are sequentially superposed in the visibility region, and which can be seen from the eye position as a single, temporally averaged reconstruction.

38. Method according to claim 3, wherein the first processor element defines the surface area of a grid cell of the grid such that it corresponds with the largest sub-hologram.
